(19) United States
(12) Patent Application Publication
(10) Pub. No.: US 2012/0320827 A1
(43) Pub. Date: Dec. 20, 2012

(54) METHOD AND APPARATUS FOR EPC CONTEXT MAINTENANCE OPTIMIZATION

(75) Inventors: Suli Zhao, San Diego, CA (US); Ajith Tom Payyappilly, San Diego, CA (US); Srinivasan Balasubramanian, San Diego, CA (US)

(73) Assignee: QUALCOMM Incorporated, San Diego, CA (US)

(21) Appl. No.: 13/460,691

(22) Filed: Apr. 30, 2012

Related U.S. Application Data
(60) Provisional application No. 61/496,993, filed on Jun. 14, 2011.

(51) Int. Cl. H04W 4/00

(52) U.S. Cl. 370/328

(57) ABSTRACT

Internet protocol (IP) continuity is fundamentally not possible when a user equipment (UE) moves from an evolved packet core (EPC) radio access technology (RAT) to a non-EPC RAT. However, there are instances when it is beneficial to not completely release an EPC IP context, such as when the UE moves to the non-EPC RAT for only a short period of time. The UE may retain an EPC IP context in a suspended state while the UE is in the non-EPC RAT, and revive the context when the UE returns to the EPC RAT. Accordingly, a method, an apparatus, and a computer program product for maintaining an EPC context at a UE are provided. The apparatus suspends and retains the EPC context when moving from an EPC capable network to a non-EPC capable network, and resumes the suspended EPC context upon returning to the EPC capable network.

### CROSS-REFERENCE TO RELATED APPLICATION(S)

This application claims the benefit of U.S. Provisional Application Ser. No. 61/496,993, entitled “METHOD AND APPARATUS FOR EPC CONTEXT MAINTENANCE OPTIMIZATION” and filed on Jun. 14, 2011, which is expressly incorporated by reference herein in its entirety.

### BACKGROUND

1. Field

The present disclosure relates generally to communication systems, and more particularly, to maintaining an EPC context when moving from an EPC capable region to a non-EPC capable region.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output (SISO), multiple-input single-output (MISO) or a multiple-input multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) system and a frequency division duplex (FDD) system. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

### SUMMARY

Long term evolution (LTE) and evolved high rate packet data (eHRPD) radio access technologies (RATs) are connected to an evolved packet core (EPC) network. Legacy technologies, such as 1x and high rate packet data (HRPD), are connected to a 3GPP2 core network. When a UE moves between areas covered by LTE (or eHRPD) and 1x (or HRPD), IP continuity is not possible since the IP core networks are different, and the UE may receive a different IP address from the two networks. A UE may disconnect applications running on the UE by replacing a previous IP data connection with a new IP data connection when the UE moves between an EPC radio access technology (RAT) and a non-EPC RAT.

However, although IP continuity may not be possible when the UE moves from the EPC RAT to the non-EPC RAT, there are instances when it is beneficial to not completely release an EPC IP context, such as when the UE moves to the non-EPC RAT for only a short period of time. The UE may retain an EPC IP context in a suspended state while the UE is in the non-EPC RAT, and revive the context when the UE returns to the EPC RAT.

In an aspect of the disclosure, a method, an apparatus, and a computer program product for maintaining an EPC context at a UE are provided. The apparatus suspends and retains the EPC context when moving from an EPC capable network to a non-EPC capable network, and resumes the suspended EPC context upon returning to the EPC capable network.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating evolved Multicast Broadcast Multimedia Service in a Multi-Media Broadcast over a Single Frequency Network.

FIG. 8 illustrates an example of a multiple access wireless communication system.

FIG. 9 is a wireless system context diagram for evolved packet core (EPC) access from a Long Term Evolution/evolved High Rate Packet Data (LTE/eHRPD) system and non-EPC access from a legacy 1x/HRPD system.

FIG. 10 illustrates an example interface diagram showing various communications among interface modules.

FIG. 11 illustrates an example first step in EPC context maintenance optimization which suspends an EPC context.

FIG. 12 illustrates an example second step in EPC context maintenance optimization which resumes an EPC context.

FIG. 13 is a flow chart of a method of wireless communication for maintaining an evolved packet core (EPC) context.

FIG. 14 is a conceptual data flow diagram illustrating the data flow between different modules/means/components in an exemplary apparatus.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

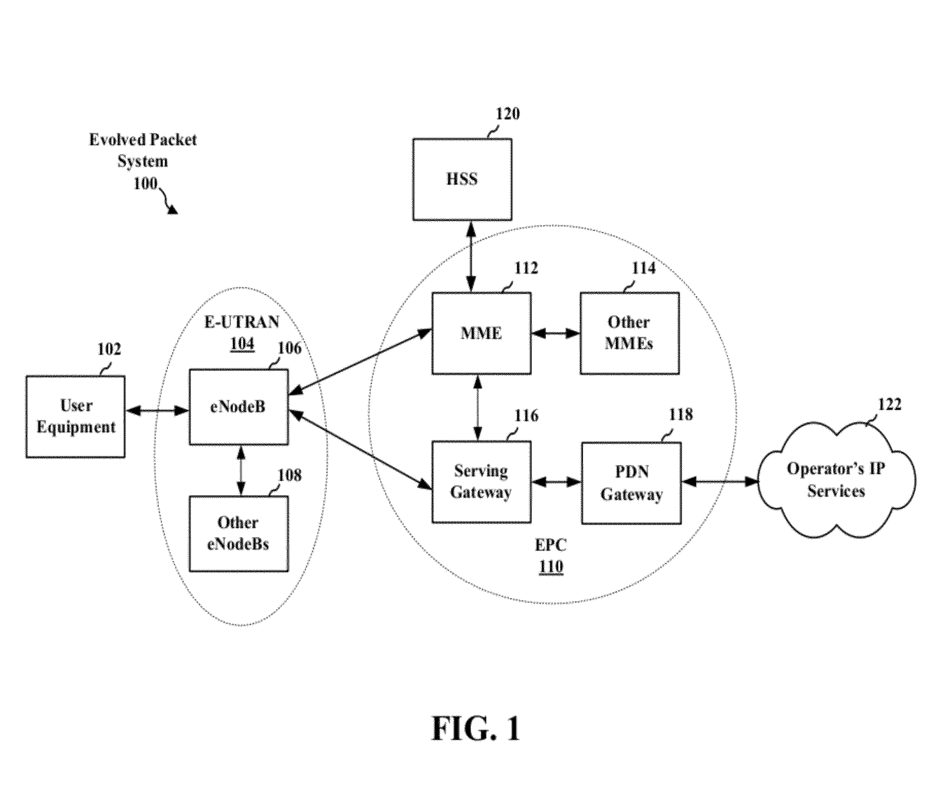

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

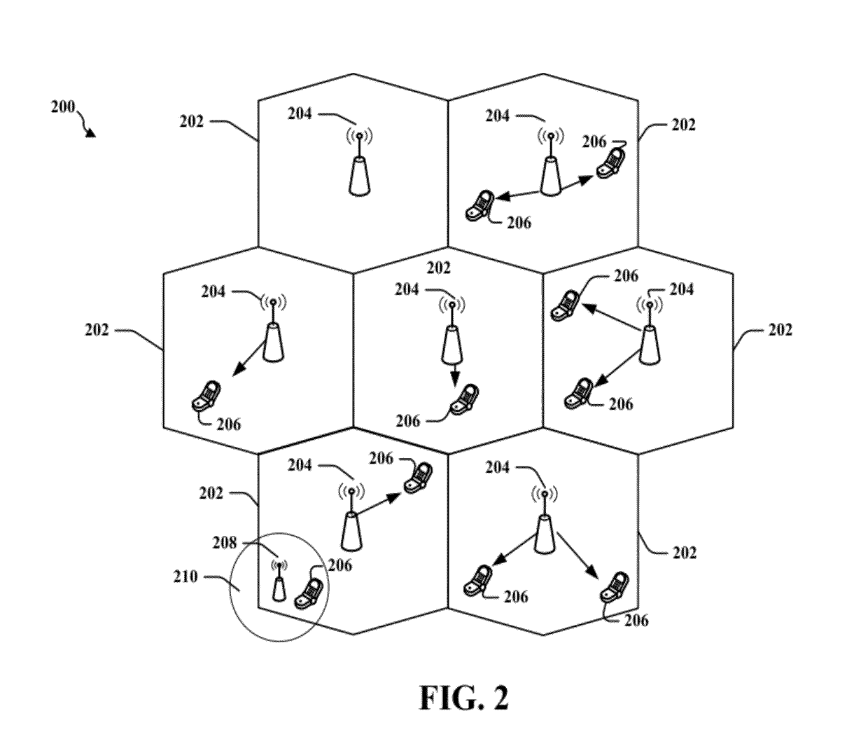

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

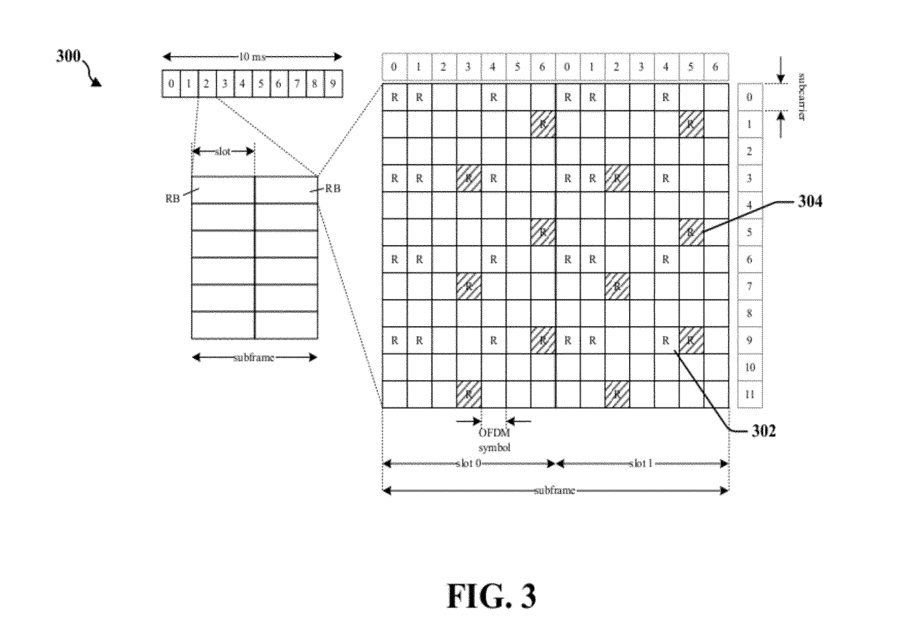

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

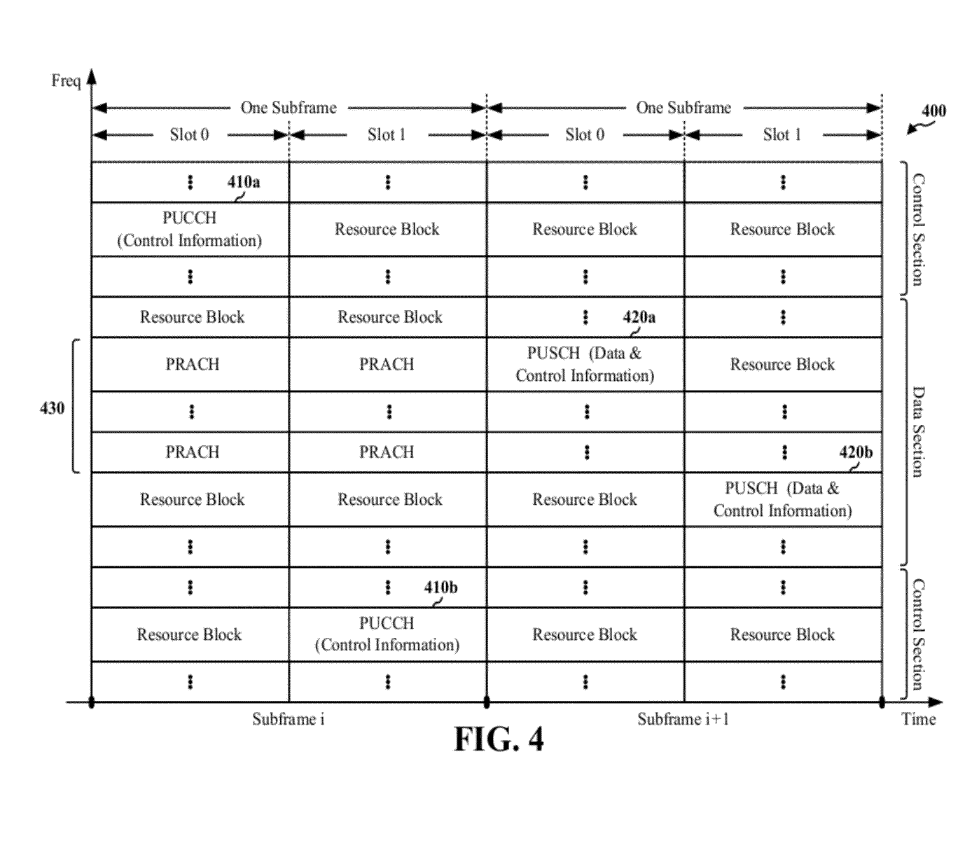

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

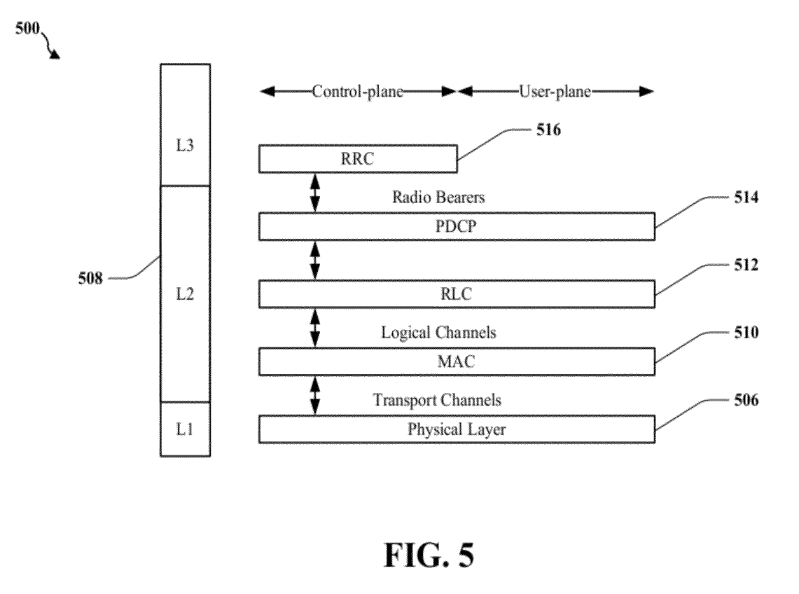

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

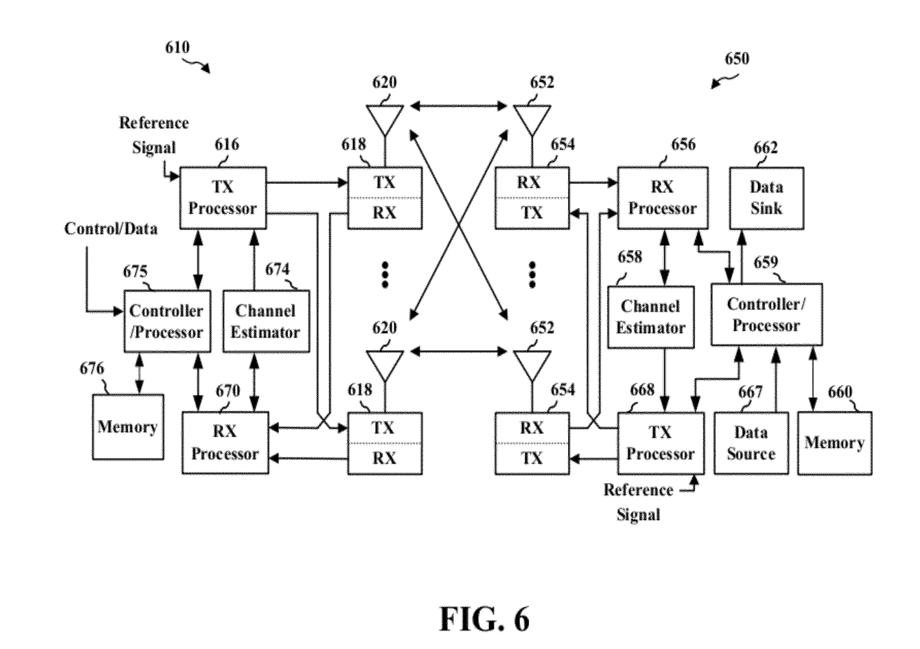

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

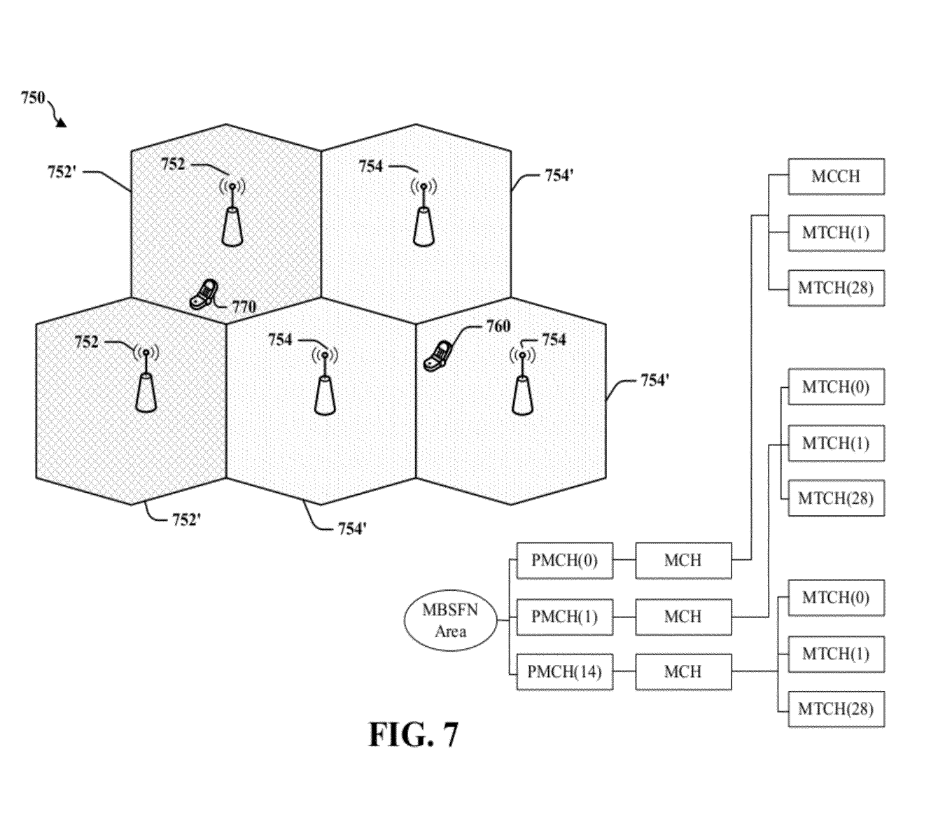

FIG. 7 is a diagram 750 illustrating evolved Multicast Broadcast Multimedia Service (eMBMS) in a Multi-Media Broadcast over a Single Frequency Network (MBSFN). The eNBs 752 in cells 752′ may form a first MBSFN area and the eNBs 754 in cells 754′ may form a second MBSFN area. The eNBs 752, 754 may be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

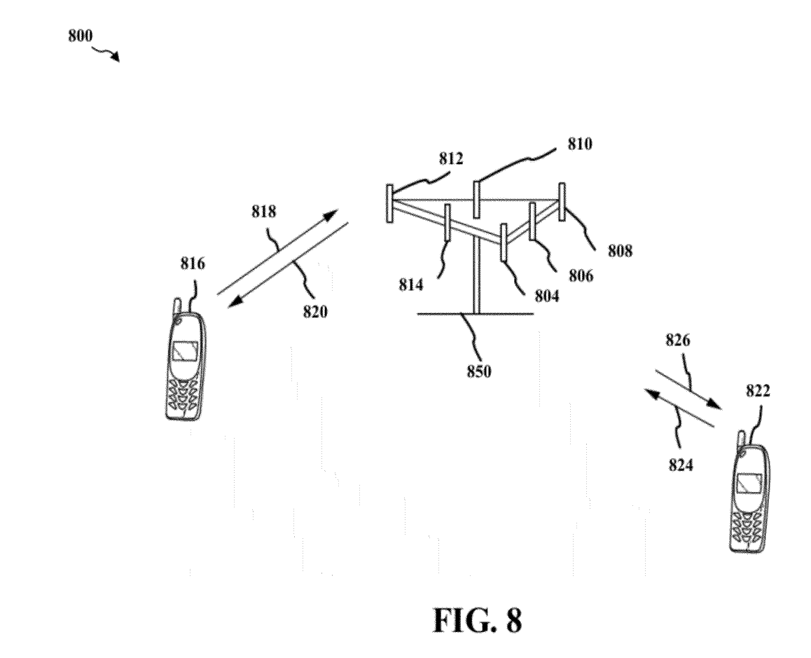

FIG. 8 is a diagram 800 illustrating an example of a multiple access wireless communication system. Referring to FIG. 8, an access point 850 (AP) includes multiple antenna groups, one antenna group including antennas 804 and 806, another antenna group including antennas 808 and 810, and an additional antenna group including antennas 812 and 814. In FIG. 8, only two antennas are shown for each antenna group, however, more or fewer antennas may be utilized for each antenna group. Access terminal 816 (AT) may be in communication with antennas 812 and 814, where antennas 812 and 814 transmit information to access terminal 816 over forward link 820 and receive information from access terminal 816 over reverse link 818. Access terminal 822 may be in communication with antennas 806 and 808, where antennas 806 and 808 transmit information to access terminal 822 over forward link 826 and receive information from access terminal 822 over reverse link 824. In a FDD system, communication links 818, 820, 824, and 826 may use a different frequency for communication. For example, forward link 820 may use a different frequency than that used by reverse link 818.

Each group of antennas and/or the area in which they are designed to communicate is often referred to as a sector of the access point. In an aspect, each of the antenna groups is designed to communicate with access terminals in a sector of the areas covered by the access point 850.

In communication over forward links 820 and 826, the transmitting antennas of the access point 850 utilize beamforming in order to improve the signal-to-noise ratio of forward links for the different access terminals 816 and 824. An access point using beamforming to transmit to access terminals scattered randomly through its coverage causes less interference to access terminals in neighboring cells than an access point transmitting through a single antenna to all its access terminals.

An access point may be a fixed station used for communicating with the terminals and also be referred to as a Node B, an eNodeB or some other terminology. An access terminal may be referred to as a mobile terminal, a mobile device, a user equipment (UE), a wireless communication device, a terminal, an access terminal or some other terminology.

In an aspect of the disclosure, an evolved packet core (EPC) is a core network for an LTE or evolved high rate packet data (eHRPD) wireless communication system. A core network serves as a common backbone infrastructure for a wireless communication system. The EPC may be comprised of the following elements: mobility management entity (MME), serving gateway (SGW), packet data network gateway (PGW), home subscriber service (HSS), access network discovery and selection function (ANDSF), evolved packet data gateway (ePDG), etc.

LTE and eHRPD Radio Access Technologies (RATs) are connected to the EPC network. Legacy technologies, such as 1x and High Rate Packet Data (HRPD), are connected to a 3GPP2 core network, for example. When a UE moves between areas covered by LTE (or eHRPD) and 1x (or HRPD), IP continuity is not possible since the IP core networks are different, and the UE may receive a different IP address from the two networks. A UE may disconnect applications running on the UE by replacing a previous IP data connection with a new IP data connection when the UE moves between an EPC radio access technology (RAT) and a non-EPC RAT.

Although IP continuity is fundamentally not possible across EPC and non-EPC RATs, there are scenarios where it is beneficial to retain an EPC IP context in a suspended state while the UE is in the non-EPC RAT, and revive the context when the UE moves back to the EPC RAT. For example, when the UE moves to the non-EPC RAT for only a very short period of time, such as when the UE moves from LTE to eHRPD, but in between encounters 1x for a very short period of time, it is beneficial for the UE to suspend the EPC IP context rather than entirely disconnect an application running on the UE.

In another example, the UE moves to a non-EPC RAT for some period of time, but during that time, no applications running on the UE actively transfer data. Thus, it may be beneficial to suspend the EPC IP context because the applications may use the data connection when the UE returns to the EPC RAT.

In a further example, some applications running on the UE may prefer to open multiple data IP interfaces across EPC and non-EPC RATs. That is, an application may prefer to open a data IP interface on the non-EPC RAT while retaining the EPC data IP interface in a suspended state, rather than tearing down the EPC data IP interface.

In an aspect of the disclosure, an apparatus, method, and computer program product are provided for retaining the EPC IP context in a suspended manner when the UE moves from an EPC RAT to a non-EPC RAT. Thus, although IP continuity may not be possible when the UE moves between EPC and non-EPC RATs, applications running on the UE do not experience a disconnect with the data IP interface. Rather, the applications only experience a suspension of the data interface and see a technology change notification. The applications are free to setup a new data interface on the non-EPC RAT if desired. When the UE returns to the EPC RAT, the previously existing data interface may be revived. This enhances the experience of the applications, and ultimately an end-user.

Examples of advantages of the present disclosure are as follows. When the UE moves from LTE to 1x to eHRPD quickly, applications running on the UE do not experience a disconnect with the data IP interface. Thus, when the UE is in eHRPD, the applications may continue to use the same IP address and will treat the movement from LTE to 1x to eHRPD as a handoff between LTE an eHRPD.

Another advantage is seen when the UE moves from the EPC RAT to the non-EPC RAT, and back to the EPC RAT after a certain period of time. For the entire duration of time when the UE is in the non-EPC RAT, applications do not need to transfer data. Thus, disconnecting applications is unnecessary. Instead, the data interfaces are suspended, and when the UE returns to the EPC RAT, the data interfaces are revived. Accordingly, the applications do not experience disconnections with the data IP interface.

A further advantage involves the allowance of some applications to open a second data interface on the non-EPC RAT to transfer data. When the UE returns to the EPC RAT, the applications return to using an original data interface the applications were originally connected to on the EPC RAT.

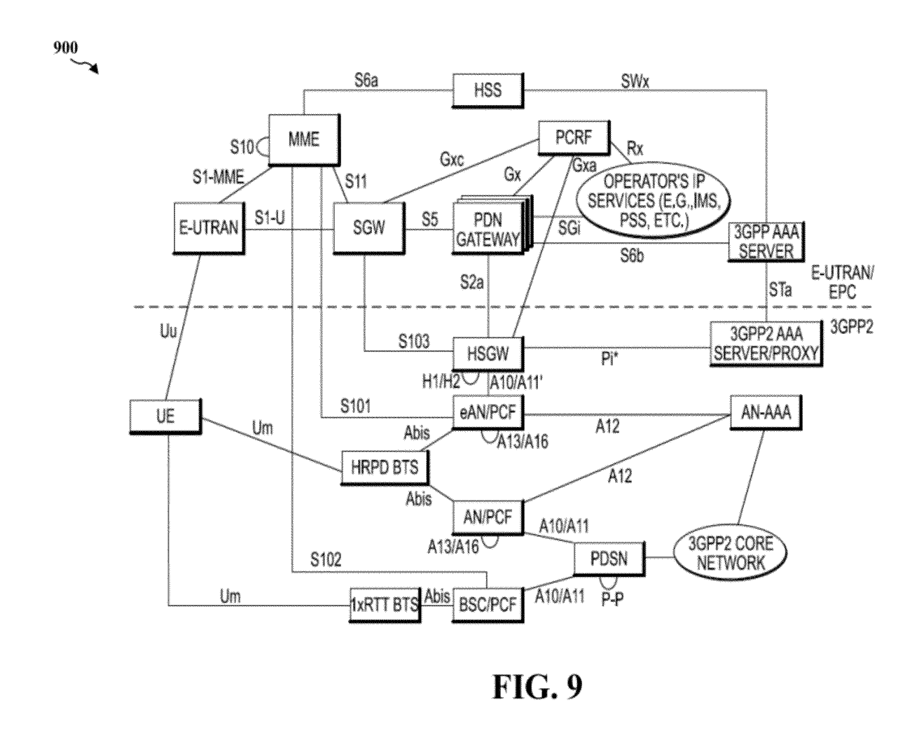

FIG. 9 is a diagram 900 illustrating an example of a wireless system context for evolved packet core (EPC) access from a Long Term Evolution/evolved High Rate Packet Data (LTE/eHRPD) system and non-EPC access from a legacy 1x/HRPD system. Referring to FIG. 9, the interface between an evolved universal terrestrial radio access network (E-UTRAN) EPC system and a 3GPP2 core network is shown. In one example, a UE may have radio access to a 1xRTT base transceiver station (BTS), HRPD BTS, and E-UTRAN.

In an example of a network scenario, a mobile device or UE transitions to a coverage area that does not support EPC (e.g., legacy 1x/HRPD-only area). In the example, all EPC context is locally released when a 1x service is declared as the serving data system after a LTE/eHRPD connection is lost. Upon trigger by an application, a UE sets up a 1x data call. However, IP context continuity will not be possible in this scenario. In addition, since the EPC context is locally released, the wireless network may not know the UE is out of a LTE/eHRPD coverage area. Mobile terminal (MT) IP Multimedia Subsystem (IMS) traffic may fail as well since it is an application that cannot use a legacy 1x data service. In one example, a MT short messaging service (SMS) may be recovered using a sequential page over IMS followed by a 1x circuit switch (CS) network. For applications which can use a 1x data service, after setting up a data session over the 1x network and registering with an application server, MT traffic may be delivered over the 1x service. When the UE returns to LTE/eHRPD service, the UE may have to re-create an EPC context upon an application trigger, wherein the UE may start by using an LTE initial attach procedure or an eHRPD point-to-point protocol (PPP) setup procedure.

In one example, after transitioning to a 1x system, all applications may receive a failure notification (including applications that work only on EPC). The UE may recreate the EPC context after returning to the LTE/eHRPD coverage area.

In an aspect, an optimization procedure may include the UE retaining and suspending an EPC context for an application. The UE may do so by flow-disabling the suspended context to an application so that the application cannot send data on the suspended context. Thereafter, the suspended EPC context may be resumed, and flow-enabled for the application, upon the UE returning to the LTE/eHRPD coverage area.

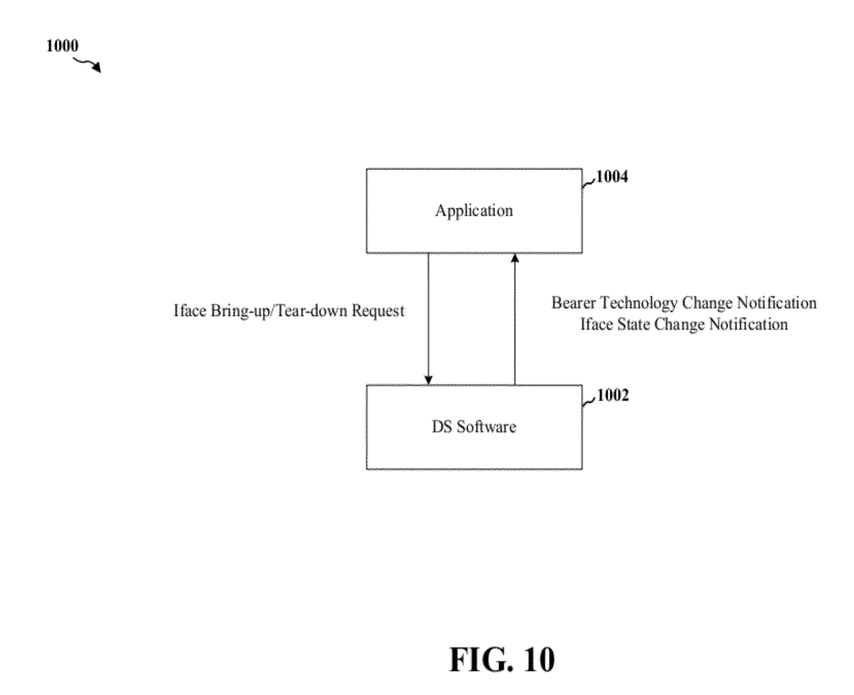

FIG. 10 is a diagram 1000 illustrating an example of a logical architecture having various communications among interface modules of a mobile device. The architecture includes a data services software (DS software) module 1002 and an application module 1004. DS software is software that manages data connections. It may include functions that manage data connections over different radio technologies, e.g., LTE, eHRPD, and 1xCS. In particular, functions of this software include maintenance of eHRPD PPP sessions, IP functionalities, and DNS functionalities. DS software also determines the serving data systems. For example, the UE may camp on LTE and 1x simultaneously; if the UE loses LTE, the DS software will declare 1x as the serving data system based on its serving data systems logic. An application is any software above the DS software that requests a wireless data session. The application module 1004 may invoke an Iface Bring-up Request message to request IP context establishment, and invoke an Iface Tear-down Request message to request IP context release.

After determining a new serving data system, the DS software module 1002 sends to the application module 1004 a Bearer Technology Change Notification message. The change of serving data system may be caused by acquisition of a new radio technology or loss of a radio technology. An Iface State Change Notification message (e.g., going-down, coming-up, down, up, configuring, etc.) may be sent from the DS software module 1002 to the application module 1004 to notify a new Iface state.

The Iface refers to the interface between an application and DS software. Each Iface may be associated with a data structure which includes an assigned IP address (IPv4 or IPv6), bearer type, flows, gateway address, etc. A single Iface may be bound to multiple applications that connect to the same PDN gateway and use the same IP address. Examples of Iface states are as follows:
1) Coming-up: A transition state in which, upon request of the application, the DS software attempts to bring up the Iface for the application.
2) Going-down: A transition state in which the DS software releases the Iface. This may be triggered by a last application bound to the Iface, or may be caused by a network-initiated PDN connection release.
3) Up: A state in which the Iface is ready for data transfer for applications.
4) Down: A state in which the Iface does not exist, and the application that requested a data connection or connected to a PDN, cannot receive data services unless the DS software brings up a new Iface.
5) Configuring: A state in which the Iface is under configuration. For example, if the UE has connected to a certain PDN and the network later initiates PPP re-sync, the Iface will transition from the Up state to the Configuring state. Alternatively, if the UE, during IPv6 address assignment procedures, receives an ID, the UE transitions from the Coming-up state to the Configuring state—later the UE will transition to the Up state after receiving the prefix from the network.

In one aspect, to support EPC context maintenance optimization, one or more of the following may need to be added to the wireless system:
1) UE supporting EPC Ifaces and non-EPC Ifaces concurrently.
2) UE supporting suspending EPC Ifaces. The UE supports a new state in Iface management: Suspend state, which is the state in which the Iface is still connected to applications but cannot transfer data for the application. If the Iface is suspended, the AMSS notifies the application of Iface Suspend. If the suspended Iface is resumed, the AMSS notifies the application of Iface Resume.
3) UE supporting an instance of PPP for 1x/HRPD concurrently with the PPP instances for eHRPD and AN-PPP.

In one example, one or more of the following may be needed by the wireless system:

1) The application understands an Iface Suspend state. If the application is notified of Iface Suspend, it is up to the application to decide whether to retain the Iface or to release the Iface. If the application decides to retain the Iface, the application will be allowed to transfer data only after receiving an Iface Resume notification. This design may relate to applications that run on the modem processor or HLOS with support from HLOS/RIL.
a) For an application that cannot use a 1x data service, the application can retain the EPC Iface.
   b) For an application that can use the 1x data service, the application can request to release the EPC Iface. After the EPC Iface is released, the application can request to bring up a new Iface on 1x/HRPD to receive data service. This feature does not require the application to support both EPC and non-EPC Ifaces at the same time.
   c) For the application that cannot support the suspended Iface, the application can release the EPC Iface.
2) The operating system (OS) supports two wireless technologies concurrently: one Iface for EPC (suspended state) and the other for non-EPC. One type of Iface may be active at a time. That is, if non-EPC Ifaces are in an Up state, then EPC Ifaces will be in a Suspend state. Moreover, because the non-EPC Ifaces do not support the Suspend state, if the EPC Ifaces are in the Up state, then the non-EPC Ifaces will be released.

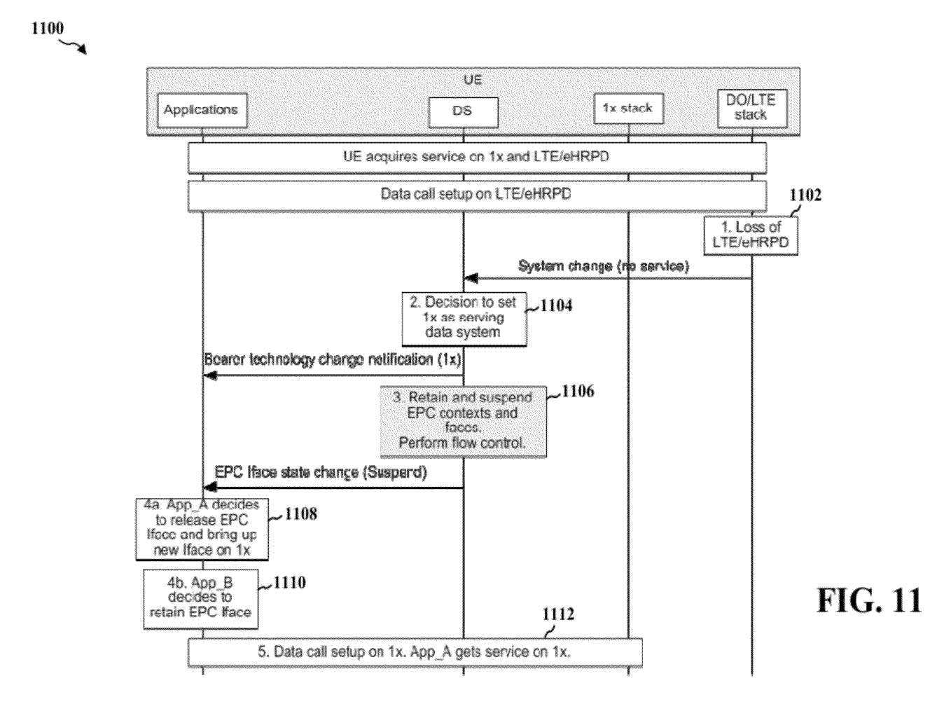

FIG. 11 is a diagram 1100 illustrating an example of the first step in EPC context maintenance optimization which suspends an EPC context when the UE moves from LTE/eHRPD to 1x/HRPD. Referring to FIG. 11, various transactions for suspending an EPC context between an Applications module, a DS module, a 1x stack, and a Data Optimized/Long Term Evolution (DO/LTE) stack when the UE moves to a 1x-only coverage area, for example, are shown.

At 1102, when the DO/LTE stack detects loss of LTE/eHRPD, the DO/LTE stack notifies the DS of “Loss of LTE/eHRPD.” At 1104, the DS determines 1x to be the serving data system and sends the Bearer Technology Change Notification message to the Applications module that had connected to any PDN connection while the UE was on LTE/eHRPD.

At 1106, the DS does not release the EPC contexts. Rather, the DS suspends all existing EPC contexts and Ifaces that were brought up for EPC. If the PDN inactivity timer is running, it will keep running. Upon expiry of the PDN inactivity timer, the UE locally clears the corresponding EPC context and releases the corresponding Iface. After suspending the EPC contexts, the DS shall notifies the Applications module of EPC Iface “Suspend.” The UE also flow controls the applications.

Upon receiving the notification of Iface Suspend, the Applications module determines whether to release the suspended EPC Iface. At 1108, for an application App_A, the Applications module decides to release a corresponding EPC Iface and bring up a new iface over 1x. At 1110, for an application App_B, the Application module decides to retain a corresponding EPC Iface.

At 1112, for the application App_A, the Applications module requests to bring up a new Iface on 1x. Upon request of the application, the DS places a data call over 1x and sets up a 1x data session. Accordingly, the UE has set up the data session over 1x allowing application App_A to receive data service over 1x while the UE has suspended the EPC context for application App_B.

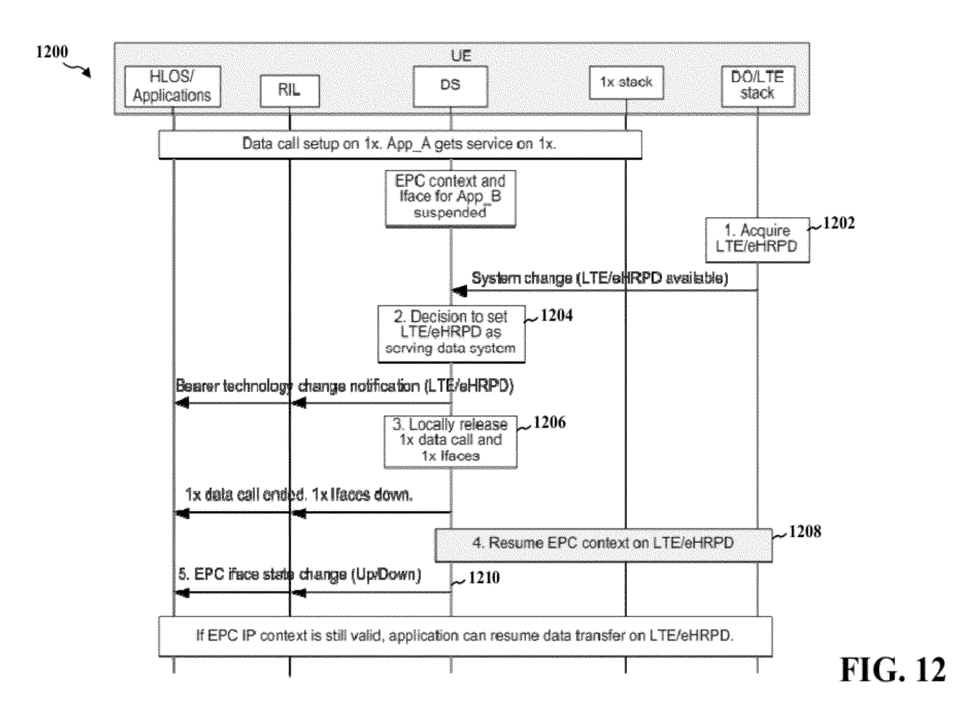

FIG. 12 is a diagram 1200 illustrating an example of the second step in EPC context maintenance optimization which resumes the EPC context when the UE moves from 1x/HRPD back to LTE/eHRPD. When moving from LTE/eHRPD to 1x/HRPD, the UE has suspended the EPC context and Iface. Upon moving back to LTE/eHRPD, the applications that did not request to release the EPC context are still bound to the suspended EPC Ifaces. Referring to FIG. 12, various transactions for resuming the EPC context between an HLOS/Applications module, an RIL module, a DS module, a 1x stack, and a Data Optimized/Long Term Evolution (DO/LTE) stack when the UE moves back from a 1x-only coverage area to LTE/eHRPD, for example, are shown.

At 1202, when the UE acquires LTE or eHRPD, the DS receives notification of a system change (LTE/eHRPD available). At 1204, the DS determines LTE/eHRPD to be the new serving data system, and sends a Bearer Technology Change Notification message indicating LTE or eHRPD to the Applications module.

At 1206, the DS locally releases the 1x data call and 1x Ifaces. The DS also notifies the Applications module of 1x Iface “Down.” At 1208, the DS resumes a data session on LTE or eHRPD. The resume procedures for LTE and eHRPD are as follows, respectively:
a) If the target system is LTE:
   1) If the UE is EMM-deregistered, the UE performs an LTE handover attachment procedure. The UE performs the handover attachment to each suspended EPC PDN connection.
   2) If the UE is EMM-registered, the UE performs an EPC bearer context sync up procedure with the network (part of LTE tracking area update procedure).
b) If the target system is eHRPD:
   1) If the UE does not have a PPP context, the UE creates a PPP context including authentication.
   2) If the UE does not have any VSNCP context (i.e., the UE was previously attached to LTE before moving to the 1x-only coverage area), the UE performs a VSNCP handover attachment procedure to each suspended EPC PDN connection.
   3) If the UE has at least one VSNCP context (i.e., the UE was previously attached to eHRPD before moving to the 1x-only coverage area):
      i) If stale PDN handling is supported, the UE initiates the PDN sync up procedure with the HSGW using LCP Echo packets. Based on the response of the HSGW, the UE locally releases the EPC context that the HSGW does not have, and performs VSNCP a handover attachment procedure to the PDN with which the HSGW has context but the UE does not have.
      ii) If stale PDN handling is not supported, the UE performs a VSNCP handover attachment procedure to each suspended EPC PDN connection.

At 1210, for each EPC IP context that is still valid, the UE notifies the Applications module of EPC Iface “Up.” Otherwise, if the IP context is invalid, the UE notifies the Applications module of EPC Iface “Down.” Accordingly, the UE has resumed a data session over LTE/eHRPD. If the EPC IP context is still valid, an application can resume data transfer over LTE/eHRPD.

Referring to FIGS. 10 and 11, in one example, a first step in EPC context maintenance optimization is to suspend an EPC context when a UE moves to a legacy coverage area that is non-EPC capable. For example, the legacy coverage area may be a 1x/HRPD coverage area. When detecting a change to 1x/HRPD-only coverage and determining that 1x/HRPD is the serving data system, the UE may send a Bearer Technology Change Notification message to an application module 1004.

Furthermore, the UE may retain and suspend all EPC contexts and ifaces, both logical and physical. For example, PDN inactivity timers may keep running and upon expiration, a corresponding IP context may be locally cleaned and a corresponding iface may be released. Next, the UE may notify the application module 1004 of EPC iface “suspend,” and flow-disable the suspended iface to applications. The determination of whether or not to release the suspended EPC iface may be performed by the application module 1004. If the application module 1004 releases the suspended EPC iface, the determination of whether or not to bring up a new iface on the 1x system may be performed by the application module 1004. If the application module 1004 requests a data service over the 1x system, the DS module 1002 may set up a 1x data session, and the application module 1004 may use the 1x data service.

Referring to FIGS. 10 and 12, in one example, a second step in EPC context maintenance optimization is to resume the EPC context when the UE returns to an LTE coverage area. If the UE detects that it enters LTE coverage and determines that LTE is the serving data system, the UE may send a Bearer Technology Change Notification to the application module 1004, and may also locally clean a 1x data call. Also, the UE may release 1x ifaces and notify the application module 1004 of a 1x iface state change to “down.” Finally, the UE may resume the EPC context. For example, if the UE is still in an EMM-Registered state, the UE may perform a EPC bearer context sync up procedure with the wireless network (e.g., part of a LTE Tracking Area Update procedure). Otherwise, if the UE is in an EMM-Deregistered state, the UE may perform an LTE handover (HO) attach procedure, where for each packet data network (PDN) connection, the UE performs a HO attach procedure. The UE may notify the application module 1006 of an EPC iface state change to “up” if an IP context is still valid. Otherwise, if the IP context is invalid, the UE may notify the application module 1006 of an EPC iface state change to “down.”

Referring to FIGS. 10 and 12, in another example of the second step in EPC context maintenance optimization, the UE may have moved from an eHRPD or LTE coverage area to a legacy coverage area (e.g., 1x coverage area), and then back to the eHRPD coverage area. If the UE detects that it enters eHRPD coverage and determines that eHRPD is the serving data system, the UE may send a Bearer Technology Change Notification to the application module 1004, and may also locally clean a 1x data call. Also, the UE may release 1x ifaces and notify the application module 1004 of a 1x iface state change to “down.” Next, the UE may resume the EPC context. If a Point to Point protocol (PPP) context is not available, the UE may create a PPP context including authentication first. If the PPP context is available, or after the PPP context is created, if a 3GPP2 Vendor Specific Network Control Protocol (VSNCP) context for each PDN connection is not available (e.g., the UE may be on LTE before moving to 1x), the UE may perform a VSNCP handoff attach procedure for each PDN connection. If the VSNCP context for each PDN connection is available (e.g., the UE may be on eHRPD before moving to 1x), the UE may perform a PDN sync up procedure with the wireless network. For example, a Link Control Protocol (LCP) Echo message may be sent, if supported. If the IP context is still valid, the UE may notify the application module 1004 of an EPC iface state change to “up.” Otherwise, if the IP context is invalid, the UE may notify the application module 1004 of an EPC iface state change to “down.”

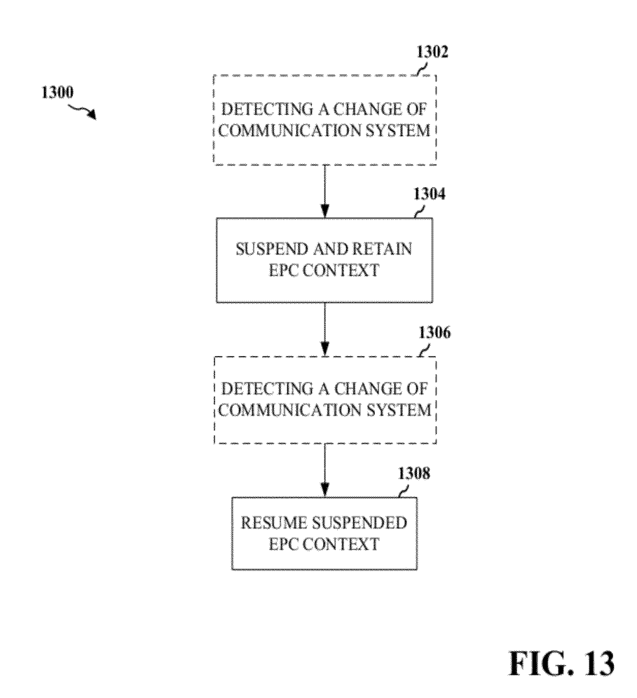

FIG. 13 is a flow chart 1300 of a method of wireless communication for maintaining an evolved packet core (EPC) context. The method may be performed by a UE. At step 1302, the UE may detect a change of the communication system when the UE moves from an EPC capable network to a non-EPC capable network. The EPC capable network may be a long term evolution (LTE) network or an evolved high rate packet data (eHRPD) network. The non-EPC capable network may be a 1x network or a high rate packet data (HRPD) network.

At step 1304, upon detecting a change of the communication system and determining that the new system is the serving data system, the UE suspends and retains the EPC context. The EPC context may include an Internet protocol (IP) context of each packet data network (PDN) connection and a data connection interface for each application activated at the UE. The suspending may include sending a message for notifying a change in communication system, and a change in Iface state, to an application activated at the UE. The message for notifying the change may be a bearer technology change notification message. Moreover, when the UE suspends the EPC context, each application activated at the UE does not experience a disconnect with the data connection interface as the UE moves from the EPC capable network to the non-EPC capable network.

At step 1306, the UE may again detect a change of the communication system when the UE returns to the EPC capable network.

At step 1308, upon detecting a change of the communication system and determining that the new system is the serving data system, the UE resumes the suspended EPC context. The resuming may include sending a message for notifying a change in communication system, and a change in Iface state, to an application activated at the UE. The message for notifying the change may be another bearer technology change notification message. The resuming may also include locally cleaning 1x data calls.

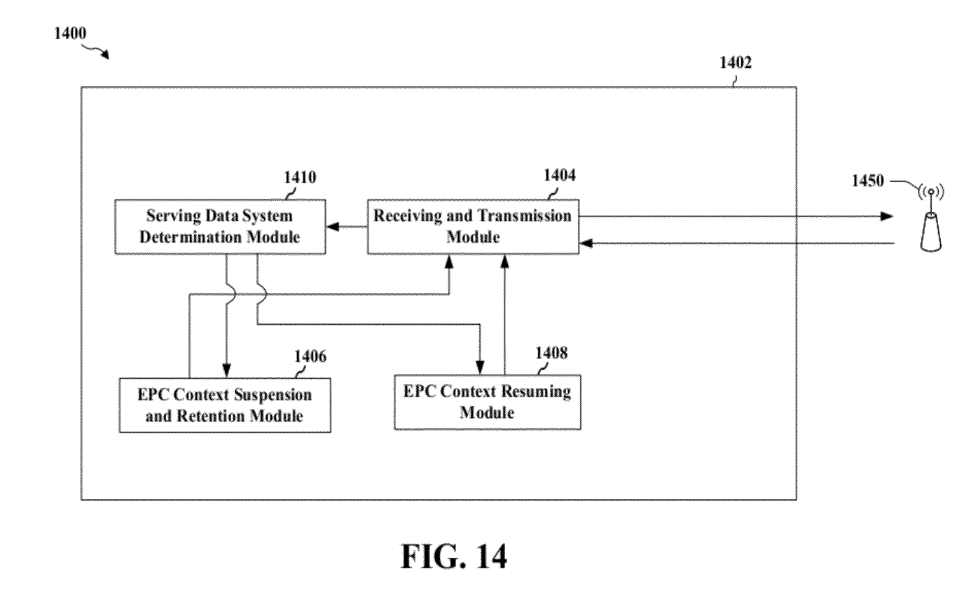

FIG. 14 is a conceptual data flow diagram 1400 illustrating the data flow between different modules/means/components in an exemplary apparatus 1402. The apparatus may be a UE communicating with a base station 1450. The apparatus includes a receiving and transmission module 1404, an EPC context suspension and retention module 1406, an EPC context resuming module 1408, and a serving data system determination module 1410.

The receiving and transmission module 1404 may detect a change of communication system when the apparatus 1402 moves from an EPC capable network to a non-EPC capable network. The EPC capable network may be a long term evolution (LTE) network or an evolved high rate packet data (eHRPD) network. The non-EPC capable network may be a 1x network or a high rate packet data (HRPD) network.

Upon detecting a change of the communication system, the serving data system determination module 1410 determines that the new system is the serving data system. After determining the new serving data system, the EPC context suspension and retention module 1406 suspends and retains the EPC context. The EPC context may include an Internet protocol (IP) context of each packet data network (PDN) connection and a data connection interface for each application activated at the apparatus 1402. The EPC context suspension and retention module 1406 may suspend by sending a message for notifying a change in communication system, and a change in Iface state, to an application activated at the apparatus 1402. The message for notifying the change may be a bearer technology change notification message. Moreover, when the EPC context suspension and retention module 1406 suspends the EPC context, each application activated at the apparatus 1402 does not experience a disconnect with the data connection interface as the apparatus 1402 moves from the EPC capable network to the non-EPC capable network.

The receiving and transmission module 1404 may again detect a change of communication system when the apparatus 1402 returns to the EPC capable network.

Upon detecting a change of the communication system, the serving data system determination module 1410 determines that the new system is the serving data system. After determining the new serving data system, the EPC context resuming module 1408 resumes the suspended EPC context. The EPC context resuming module 1408 may resume by sending another message for notifying a change in communication system, and a change in Iface state, to an application activated at the apparatus 1402. The message for notifying the change may be another bearer technology change notification message. The EPC context resuming module 1408 may also resume by locally cleaning 1x data calls.

The apparatus may include additional modules that perform each of the steps of the algorithm in the aforementioned flow chart of FIG. 13. As such, each step in the aforementioned flow chart of FIG. 13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

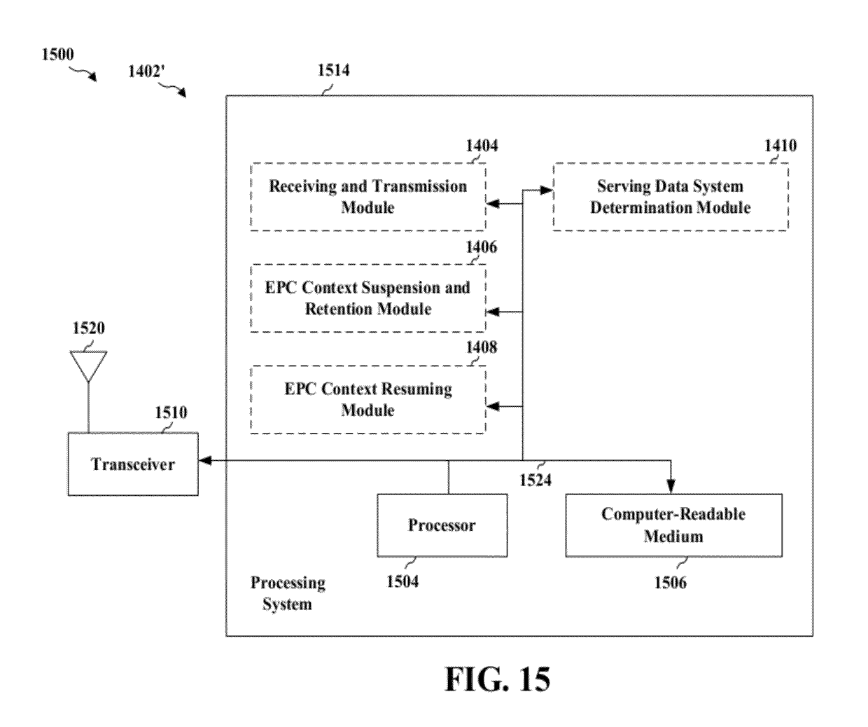

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware modules, represented by the processor 1504, the modules 1404, 1406, 1408, 1410, and the computer-readable medium 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The processing system 1514 includes a processor 1504 coupled to a computer-readable medium 1506. The processor 1504 is responsible for general processing, including the execution of software stored on the computer-readable medium 1506. The software, when executed by the processor 1504, causes the processing system 1514 to perform the various functions described supra for any particular apparatus. The computer-readable medium 1506 may also be used for storing data that is manipulated by the processor 1504 when executing software. The processing system further includes at least one of the modules 1404, 1406, 1408, and 1410. The modules may be software modules running in the processor 1504, resident/stored in the computer readable medium 1506, one or more hardware modules coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication includes means for suspending and retaining an evolved packet core (EPC) context when moving from an EPC capable network to a non-EPC capable network, and means for resuming the suspended and retained EPC context upon returning to the EPC capable network. The aforementioned means may be one or more of the aforementioned modules of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX

Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication for maintaining an evolved packet core (EPC) context at a user equipment (UE), the method comprising:
suspending and retaining an evolved packet core (EPC) context when moving from an EPC capable network to a non-EPC capable network; and
resuming the suspended EPC context upon returning to the EPC capable network.

2. The method of claim 1, wherein the EPC context includes an Internet protocol (IP) context of each packet data network (PDN) connection and a data connection interface for each application activated at the UE.

3. The method of claim 2, wherein each application activated at the UE does not experience a disconnect with the data connection interface when the UE moves from the EPC capable network to the non-EPC capable network.

4. The method of claim 1, wherein the suspending is performed upon detecting a change of the communication system.

5. The method of claim 1, wherein the suspending comprises sending a message for notifying a change in communication system and a change in Iface state to an application activated at the UE.

6. The method of claim 1, wherein the resuming is performed upon detecting a change of the communication system.

7. The method of claim 1, wherein the resuming comprises sending a message for notifying a change in communication system and a change in Iface state to an application activated at the UE.

8. The method of claim 1, wherein the EPC capable network is a long term evolution (LTE) network or an evolved high rate packet data (eHRPD) network, and the non-EPC capable network is a 1x network or a high rate packet data (HRPD) network.

9. A user equipment (UE) for maintaining an evolved packet core (EPC) context, comprising:
means for suspending and retaining an evolved packet core (EPC) context when moving from an EPC capable network to a non-EPC capable network; and
means for resuming the suspended EPC context upon returning to the EPC capable network.

10. The UE of claim 9, wherein the EPC context includes an Internet protocol (IP) context of each packet data network (PDN) connection and a data connection interface for each application activated at the UE.

11. The UE of claim 10, wherein each application activated at the UE does not experience a disconnect with the data connection interface when the UE moves from the EPC capable network to the non-EPC capable network.

12. The UE of claim 9, wherein the means for suspending is configured to suspend upon detecting a change of the communication system.

13. The UE of claim 9, wherein the means for suspending is configured to send a message for notifying a change in communication system and a change in Iface state to an application activated at the UE.

14. The UE of claim 9, wherein the means for resuming is configured to resume upon detecting a change of the communication system.

15. The UE of claim 9, wherein the means for resuming is configured to send a message for notifying a change in communication system and a change in Iface state to an application activated at the UE.

16. The UE of claim 9, wherein the EPC capable network is a long term evolution (LTE) network or an evolved high rate packet data (eHRPD) network, and the non-EPC capable network is a 1x network or a high rate packet data (HRPD) network.

17. A user equipment (UE) for maintaining an evolved packet core (EPC) context, comprising:
a processing system configured to:
suspend and retain an evolved packet core (EPC) context when moving from an EPC capable network to a non-EPC capable network; and
resume the suspended and EPC context upon returning to the EPC capable network.

18. The UE of claim 17, wherein the EPC context includes an Internet protocol (IP) context of each packet data network (PDN) connection and a data connection interface for each application activated at the UE.

19. The UE of claim 18, wherein each application activated at the UE does not experience a disconnect with the data connection interface when the UE moves from the EPC capable network to the non-EPC capable network.

20. The UE of claim 17, wherein the processing system is configured to suspend upon detecting a change of the communication system.

21. The UE of claim 17, wherein the processing system configured to suspend is further configured to send a message for notifying a change in communication system and a change in Iface state to an application activated at the UE.

22. The UE of claim 17, wherein the processing system is configured to resume upon detecting a change of the communication system.

23. The UE of claim 17, wherein the processing system configured to resume is further configured to send a message for notifying a change in communication system and a change in Iface state to an application activated at the UE.

24. The UE of claim 17, wherein the EPC capable network is a long term evolution (LTE) network or an evolved high rate packet data (eHRPD) network, and the non-EPC capable network is a 1x network or a high rate packet data (HRPD) network.

25. A computer program product for maintaining an evolved packet core (EPC) context at a user equipment (UE), comprising:
a computer-readable medium comprising code for:
suspending and retaining an evolved packet core (EPC) context when moving from an EPC capable network to a non-EPC capable network; and
resuming the suspended EPC context upon returning to the EPC capable network.
